(19) United States
(12) Patent Application Publication
(10) Pub. No.: US 2010/0288029 A1
(43) Pub. Date: Nov. 18, 2010

(54) SYSTEM AND METHOD FOR CHARACTERIZING MEMBRANES AND MEMBRANE FILTRATION DEVICES

(75) Inventor: Jiang Ji, Billerica, MA (US)

Correspondence Address: GE HEALTHCARE BIO-SCIENCES CORP.;PATENT DEPARTMENT, 101 CARNEGIE CENTER, PRINCETON, NJ, 08540, US

(73) Assignee: GE HEALTHCAR BIO-SCIENCES CORP., Piscataway, NJ (US)

(21) Appl. No.: 12/377,936

(22) PCT Filed: Aug. 28, 2007
(86) PCT No.: PCT/US07/76944

§ 371 Date: Feb. 18, 2009

Related U.S. Application Data
(60) Provisional application No. 60/823,931, filed on Aug. 30, 2006.

(51) Int. Cl. G01N 9/00

(52) U.S. Cl. 73/64.54

(57) ABSTRACT

A system for characterizing a membrane is disclosed. The system includes a container configured to dissolve a first large molecular weight marker and a second large molecular weight marker into a solution, wherein the container is connected to a reservoir. The reservoir configured to receive the solution. A filtration unit is connected to the reservoir, where the filtration unit is configured to separate the first large molecular weight marker and the second large molecular weight marker from the solution. A measuring system is configured to determine if the first large molecular weight marker is equal to or larger than a first target concentration, where if the first large molecular weight marker is equal to or larger than the first target concentration then the first large molecular weight marker it meets a first criteria for rejection by said membrane. The measuring system is also configured to determine if the second large molecular weight marker is equal to or smaller than a second target concentration, where if the second large molecular weight marker is equal to or smaller than the second target concentration then the second large molecular weight marker meets a second criteria for passage through said membrane.

### CROSS-REFERENCE TO RELATED APPLICATIONS

This application claims priority to U.S. provisional patent application No. 60/823,931 filed Aug. 30, 2006; the entire disclosure of which is incorporated herein by reference in its entirety.

### FIELD OF THE INVENTION

The present invention relates to a system and method for characterizing membranes and membrane filtration devices.

### BACKGROUND OF THE INVENTION

Generally, filtration devices or membrane separation technology are utilized by pharmaceutical and biotechnology companies to separate cells, proteins, surfactants and other biological materials from solutions. The cells, proteins, surfactants and biological materials are utilized by the pharmaceutical and biotechnology companies to develop drugs for the treatment of illnesses, diseases and the like.

There have been numerous patents that include membrane separation technology for the extraction of biological materials from solutions. In U.S. Pat. No. 6,939,697, there is a process to concentrate insoluble proteins by utilizing a vibrating membrane filtration. The proteins in this invention included ProtD-Mage-3-His protein expressed in E. Coli; NS1-P703-His protein expressed in E. Coli; and Nef-Tat-His protein expressed in Pichia Pastoris. There are also several U.S. Pat. Nos. 6,800,732, 6,342,374 and 6,090,585 which disclose purification of human collagenase inhibitor from human amniotic fluid by using UF membranes and chromatography to achieve inhibitor purity over 95%.

Even though there are useful membranes produced for the pharmaceutical and biotechnology companies, there are problems associated with producing specific membranes for these companies. First, the valuable biotechnology/pharmaceutical products filtered by membranes are often not available to membrane manufacturers so the manufacturers are not sure if their membranes meet the goals of the biotechnology/pharmaceutical companies. Also, the criteria for how much biotechnology materials need to be separated from a solution are not adequately disclosed to membrane manufacturers for them to comply with this criteria. For example, if the companies require that at least 92% thyroglobulin needs to be retained in a concentrated solution from a feed solution containing 500 ppm thyroglobulin buffer solution, then a membrane is needed that can only provide less than 8% passage of thyroglobulin into a permeate solution. Further, in order to meet the demands from biotechnology/pharmaceutical companies, the membrane manufacturing companies sometimes have to make a membrane product under several slightly different conditions, but within the allowed variation limits of the standard operation conditions. The companies hopes that at least a portion of the products made under these conditions meets the specification of their biotechnology customers, which is not an efficient approach, because it creates a lot of problems for membrane companies, such as unnecessary product waste and delayed product delivery. The portion of the product, that does not meet the biotechnology/pharmaceutical specification criteria are often a large portion of the products sold to biotechnology and pharmaceutical industries and becomes waste. The wasted products have to be disposed of if no other application is found for them, which is often the case.

Most of the biotechnology and pharmaceutical produced products are related to proteins and nucleic acids. Commonly used molecular weight markers in membrane industry, such as water soluble polyvinylpyrrolidone, polyethylene glycol, polyethylene oxide, dextran and other polysaccharides often give poor correlations with biotechnology and pharmaceutical specifications or wrong predictions for protein separations. Therefore, there is a need for a system for an effective membrane characterization that allows the membrane manufacturer to prepare a membrane that will accurately meet the needs of the biotechnology and pharmaceutical companies.

### SUMMARY OF THE INVENTION

The present invention has been accomplished in view of the above-mentioned technical background, and it is an object of the present invention to provide a system and method for characterizing membranes and membrane filtration devices with emphasis on those membranes and membrane devices manufactured for applications in biotech and pharmaceutical industries.

In a preferred embodiment of the invention, a system for characterizing a membrane is disclosed. The system includes a container configured to dissolve a first large molecular weight marker and a second large molecular weight marker into a buffer solution, wherein the container is connected to a reservoir. The first molecular weight marker is selected for measuring retention by said membrane, while the said second largest molecular marker is selected for measuring passage through the membrane. The reservoir is configured to store a feed solution and to receive a recycled concentrated solution. A filtration unit is connected to the reservoir, where the filtration unit is configured to separate the first large molecular weight marker from the second large molecular weight marker in the buffer solution. A measuring system is configured to determine if the first large molecular weight marker is equal to or larger than a first target concentration, where if the first large molecular weight marker is equal to or larger than the first target concentration then the first large molecular weight marker meets a first criteria for rejection by the membrane. The measuring system is also configured to determine if the second large molecular weight marker is equal to or smaller than a second target concentration, where if the second large molecular weight marker is equal to or smaller than the second target concentration then the second large molecular weight marker meets a second criteria for passage through the membrane.

In another preferred embodiment of the invention, a method for characterizing a membrane is disclosed. A solution is formed by dissolving a first large molecular weight marker and a second large molecular weight marker in a solvent. The solution is filtered where the first large molecular weight marker and the second large molecular weight marker are separated from each other. There is a determination if the first large molecular weight marker is equal to or larger than a first target concentration, where the first large molecular weight marker is equal to or larger than the first target concentration then the first large molecular weight marker meets a first criteria for rejection. Also, there is a determination if the second large molecular weight marker is equal to or smaller than a second target concentration, where if the second large molecular weight marker is equal to or smaller than the second target concentration then the second large molecular weight marker meets a second criteria for passage.

### BRIEF DESCRIPTION OF THE DRAWINGS

These and other advantages of the present invention will become more apparent as the following description is read in conjunction with the accompanying drawings, wherein:

FIG. 1 is a schematic diagram of a filtration system in accordance with an embodiment of the invention;

FIG. 2 is a flow-chart that depicts how the filtration system of FIG. 1 is utilized in accordance with an embodiment of the invention;

FIG. 3 illustrates an internal surface of three hollow fiber membranes in accordance with an embodiment of the invention;

FIG. 4 illustrates a version of an external surface of three hollow fiber membranes in accordance with an embodiment of the invention;

FIG. 5 illustrates a magnified external surface of three hollow fiber membranes in accordance with an embodiment of the invention;

FIG. 6 illustrates a cross section of the three hollow fiber membranes of FIG. 3 in accordance with an embodiment of the invention;

FIG. 7 illustrates enlarged views of the cross section of three hollow fiber membranes of FIG. 5 in accordance with an embodiment of the invention;

FIG. 8 is a graphical representation of apoferrintin retention in the membrane versus time in accordance with an embodiment of the invention;

FIG. 9 is a graphical representation of thyroglobulin retention in the membrane versus time in accordance with an embodiment of the invention; and

FIG. 10 illustrates a flux of thyroglobulin/Buffer-M across the different types of hollow fiber membranes in accordance with an embodiment of the invention.

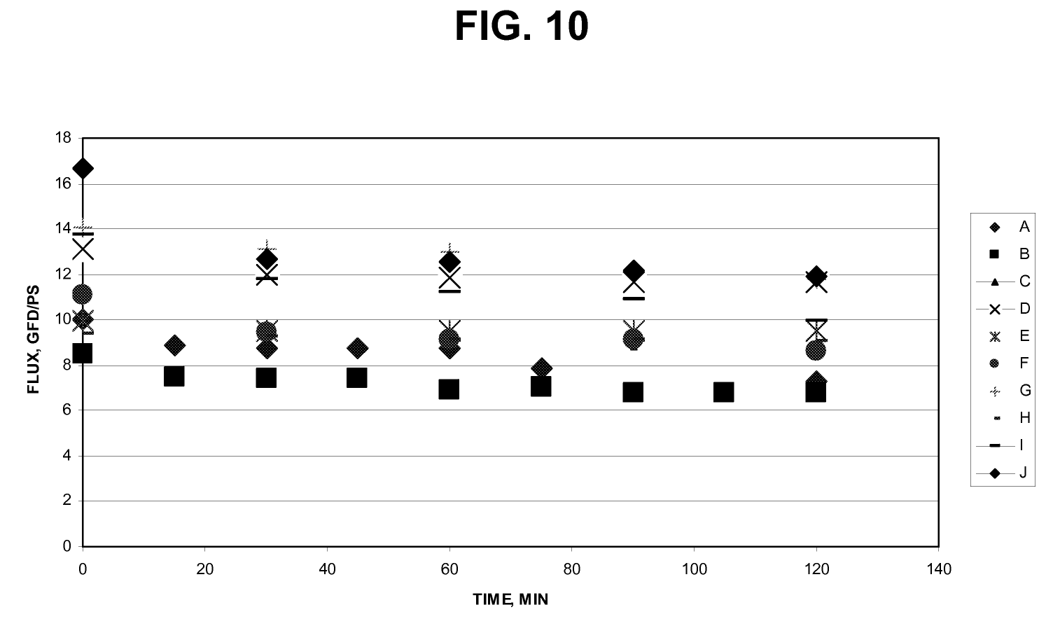

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

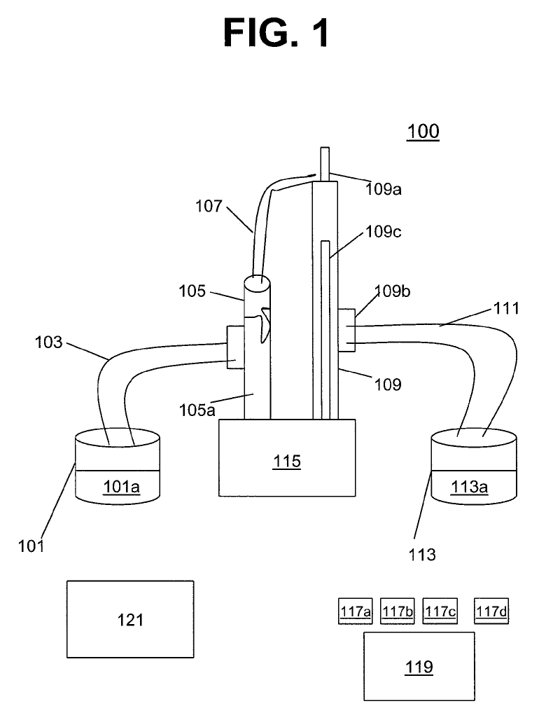

FIG. 1 illustrates the filtration system. Filtration system 100 includes the following components: a first container 101, a first conduit 103, a reservoir 105, a second conduit 107, a filtration unit 109, a third conduit 111, a second container 113, a laboratory scale 115, a first cuvette 117a, a second cuvette 117b, a third cuvette 117c, a fourth cuvette 117d, a spectrometer 119 and a computer 121. First conduit 103, second conduit 107 and the third conduit 111 may also be referred to as tubing. In this embodiment, the first container 101 contains pharmaceutical, biological and/or biotechnology materials in a solution or liquid 101a that will be filtered by the filtration unit 109. The first container 101 and second container 113 are typical laboratory measuring beakers or containers or they may be any type of container that can hold a pharmaceutical or biological solution. Lab scale 115 has a first conduit 103 that draws or pumps the solution 101a by utilizing a pump unit (not shown) of the lab scale 115 into the reservoir 105, where the solution 101a will be referred to as 105a. Reservoir 105 is a typical reservoir utilized to store a pharmaceutical/biological or biotechnology solution on top of the lab scale 115.

Lab scale 115 is a typical electronic top loading balance position and adjusted for measuring the weight of the liquid 105a in the reservoir 105. Any type of electronic top loading balance may be utilized, such as the Mettler®, PM Series, Sartorius®, MCI Series and Ohaus® GT Series and the QuixStand™. Preferably, the QuixStand™ which is manufactured by GE Healthcare will be utilized as the lab scale 115. The lab scale 115 also pumps the solution 105a from the reservoir to the filtration unit 109.

Filtration unit 109 includes an inlet 109a and a retenate outlet 109b. Retenate outlet 109b may also be referred to as a collector. Collector 109b is utilized to collect the filtrate (or permeate) 113a which, by operation of the filtration unit 109, is separated from the solution 101a and flows out of the pump unit of the lab scale 115.

Typically the filtration unit 109 will take the form of tangential or cross-flow hollow fiber cartridge of a type that is presently available. There are other filtration units that can be used, including those characterized as spiral and dead-end filtration devices.

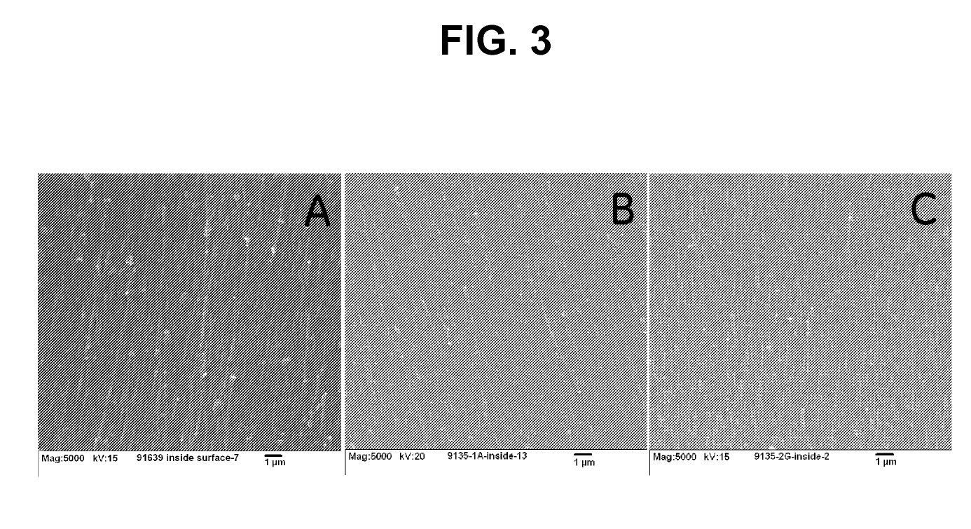

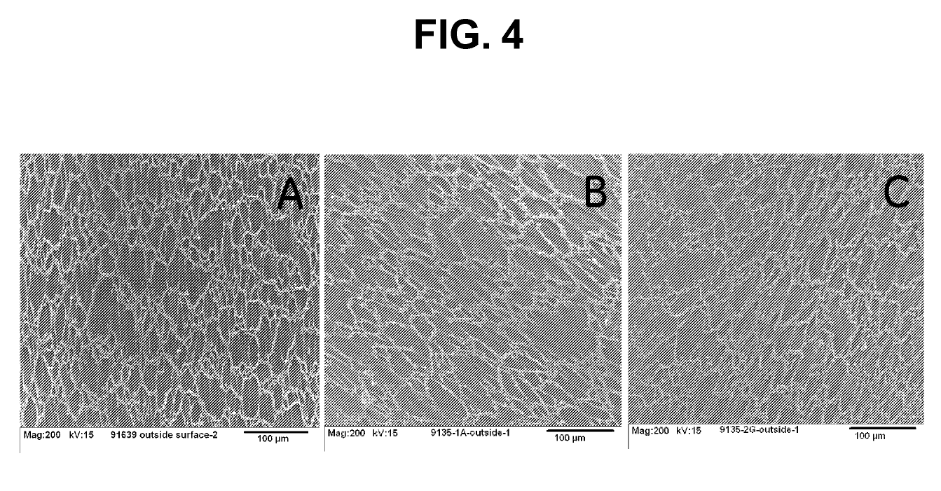

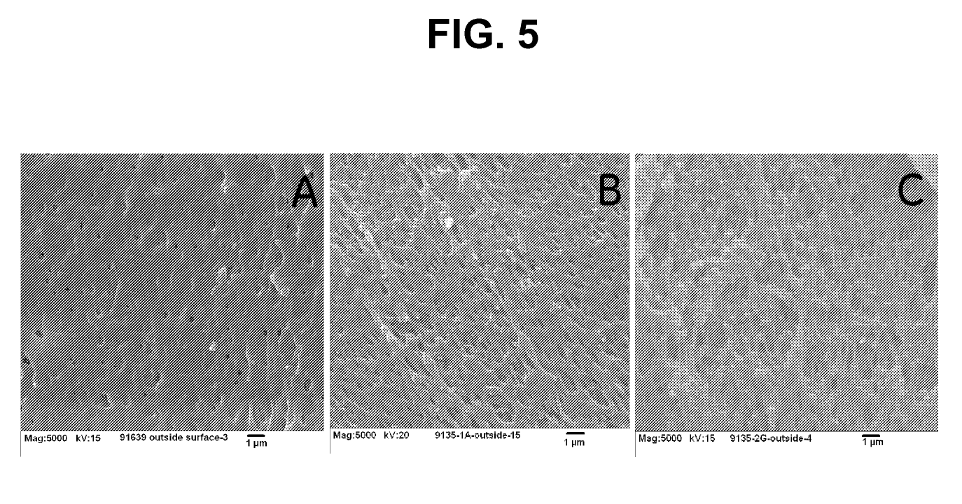

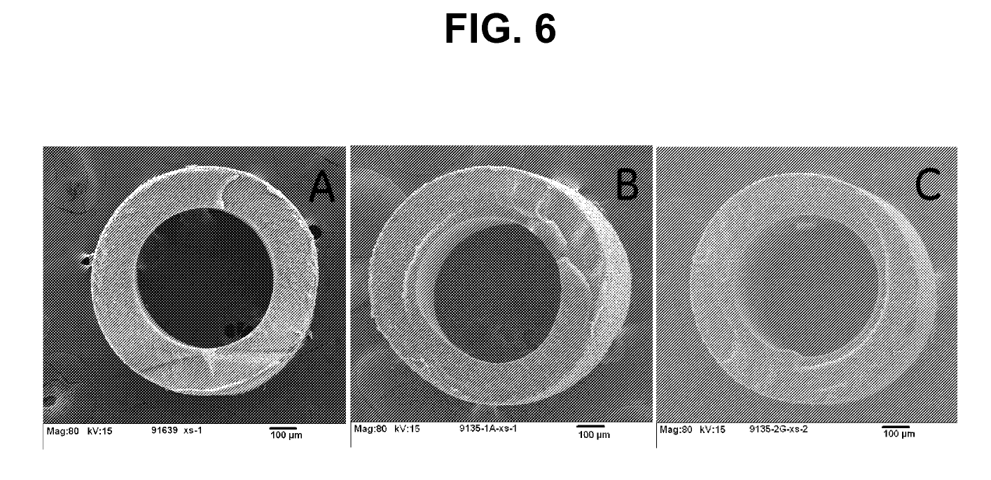

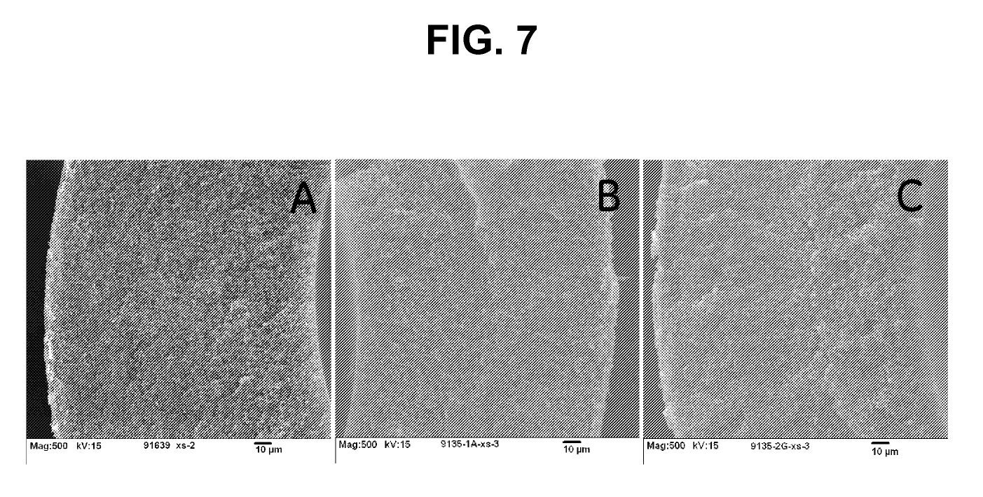

The filter units 109 may be of the type wherein the liquid to be filtered encounters a porous membrane or hollow fiber 109c. This filter unit 109 may be of any type of unit which incorporates typical porous filtration device 109c or hollow fiber membranes, and the flow of liquid is of a generally tangential type or cross-flow type. FIGS. 3-7 each illustrate three different types of hollow fibers A, B and C for hollow fiber 109c that may be utilized in this invention. FIG. 3 shows the internal surface of the hollow fibers A, B and C. FIG. 4 depicts the outside surface of the hollow fibers A, B and C magnified 200 times. FIG. 5 shows enlarged view of the outside surface of hollow fibers A, B and C. FIG. 6 depicts a cross section of hollow fibers A, B and C where the hollow fibers A, B and C are magnified 80 times. FIG. 7 shows another cross-section of hollow fibers A, B and C where the hollow fibers A, B and C are magnified 500 times.

Hollow fiber 109c is generally well-known. The fiber or membrane 109c has a variety of pore sizes which are selected to achieve the desired separation performance. Membrane 109c may also be referred to as a flat sheet membrane or a tubular membrane. Commercially available filtration units include those which are stacked plate and spiral devices which use flat membranes. Others include tubular devices, as well as shell and tube devices which use hollow fiber membranes. Cross-flow or tangential ultrafiltration, diafiltration or dialysis filter units operate on the principle of providing high fluid flow velocity parallel to the membrane surface. When the solution 105a is filtered by the filtration unit 109, then the solution is transferred through conduit 111 to the second container 113 as a permeate solution 113a. A portion of the solution 105a is separated by hollow fiber membrane 109c and is retained in hollow fiber 109c; this separate solution is referred to as a retenate solution. At the second container 113, then the permeate solution 113a and the solution 101a or feed solution 101a is transferred to the first cuvette 117a, second cuvette 117b, third cuvette 117c and a fourth cuvette 117d, then a protein concentration or a surfactant concentration is measured for the permeate solution 113a and the feed solution 101a by the spectrometer 119. Spectrometer 119 is a typical Ultra-violet spectrometer utilized by one of ordinary skill in the art. Next to the spectrometer 119 is the standard or typical computer 121 that determines the first large molecular weight marker and the second large molecular weight marker by utilizing the measured permeate solution 113a and the feed solution 101a.

Typical or conventional computer 121 may be a personal digital assistant (PDA), laptop computer, notebook computer, mobile telephone, media player, hard-drive based device or any device that can receive, send and store information. Also, a processor, an input/output (I/O) controller, a mass storage, a memory, a video adapter, a connection interface and a system bus that operatively, electrically or wirelessly, couples the aforementioned systems components to the processor. Also, the system bus, electrically or wirelessly, operatively couples typical computer system components to the processor. The processor may be referred to as a processing unit, a central processing unit (CPU), a plurality of processing units or a parallel processing unit. System bus may be a typical bus associated with a conventional computer. Memory includes a read only memory (ROM) and a random access memory (RAM). ROM includes a typical input/output system including basic routines, which assists in transferring information between components of the computer during start-up.

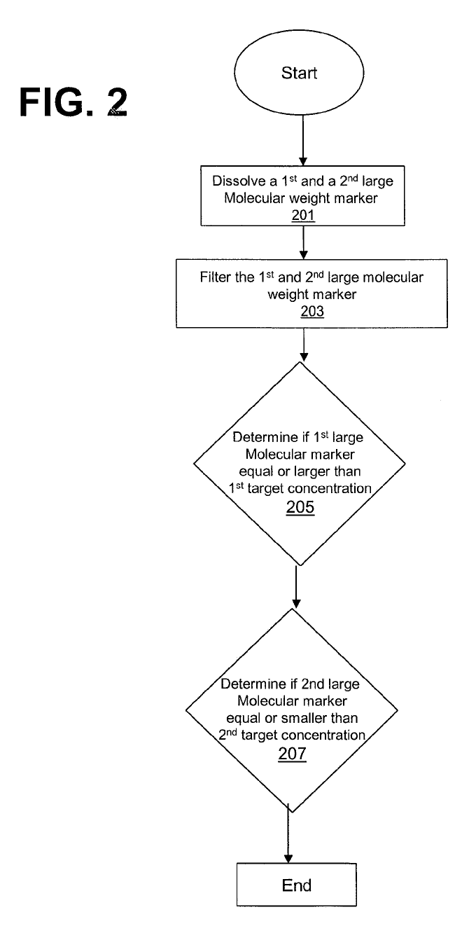

Above the memory is the mass storage, which includes: 1. a hard disk drive component (not shown) for reading from and writing to a hard disk and a hard disk drive interface (not shown), 2. a magnetic disk drive (not shown) and a hard disk drive interface (not shown) and 3. an optical disk drive (not shown) for reading from or writing to a removable optical disk such as a CD-ROM or other optical media and an optical disk drive interface (not shown). The aforementioned drives and their associated computer readable media provide non-volatile storage of computer-readable instructions, data structures, program modules and other data for the computer 121. Also, the aforementioned drives that have the technical effect of: determining if the first large molecular weight marker is equal to or larger than the 1^{st} target concentration and determining if the second large molecular weight marker is equal to or smaller than a 2^{nd} target concentration that is stored in an algorithm, software or equation of this invention, which will be described in the flow chart of FIG. 2 that works with the processor.

Input/output controller is connected to the processor by the bus, where the input/output controller acts as a serial port interface that allows a user to enter commands and information into the computer through an input device, such as a keyboard and pointing devices. The typical pointing devices utilized are joysticks, mouse, game pads or the like. A display is electrically or wirelessly connected to the system bus by the video adapter. Display may be the typical computer monitor, Liquid Crystal Display, High-Definition TV (HDTV), projection screen or a device capable of having characters and/or still images generated by a computer. Next to the video adapter of the computer, is the connection interface. The connection interface may be referred to as a network interface. Also, the computer 121 may include a network adapter or a modem, which enables the computer 121 to be coupled to other computers.

FIG. 2 depicts a flow-chart of how the filtration system is employed. At block 201, a solution is formed by dissolving a first large molecular weight marker and a second large molecular weight marker in a solvent in a container 101 (FIG. 1). The first large molecular weight marker may be any type of chemical or protein, such as thyroglobulin, apoferrintin, hemoglobin, monoclonal antibody, bovine serum albumin or the like. A sample of the first large molecular weight marker is set aside as a first target concentration that will be utilized later in this process for measuring the marker retention by the membrane. The second large molecular weight marker is another chemical or a surfactant, such as sorbitane monooleate, tween 20-85, PS 80 and triton x 100 or the like. A sample of the second large molecular weight marker is set aside as a second target concentration that will be utilized later in this process for measuring the marker passage through the membrane.

For example, the first large molecular weight marker is 1000 ppm (parts per million) of thyroglobulin buffer solution is prepared by dissolving thyroglobulin in a typical or standard buffer solution while in the container 101. In an embodiment of the invention, the buffer solution may be a dissolved mixture of 2-6 liters of deionized water, 200-300 grams of Sodium Chloride, 70-80 grams of Sodium Citrate and 1-2 grams of Calcium Chloride. Preferably, the buffer solution includes: 5 liters of deionized water, 292.2 grams of Sodium Chloride, 73.53 grams of Sodium Citrate and 1.11 grams of Calcium Chloride. The container 101 is placed on a stir plate and mixed at a room temperature until all of the thyroglobulin is dissolved into the standard buffer, which may take up to 2 or more hours. In another embodiment of the invention, the first large molecular weight marker is a 1000 ppm apoferrintin buffer solution that is prepared by dissolving apoferrintin in the typical buffer solution describe above. In yet another embodiment of the invention, the buffer solution may be 1-3 M of sodium chloride, 40-60 mM of sodium citrate basic dehydrate, 1-3 mM of calcium chloride at pH 6.0-6.3. Preferably, the buffer solution is 1 M of sodium chloride, 50 mM of sodium citrate basic dehydrate, 2 mM of calcium chloride at pH 6.2. Also, the container 101 is placed on a typical stir plate and mixed at a room temperature until all of the apoferrintin is dissolved into the standard buffer solution, which may take up to 2 or more hours.

For the second large molecular weight marker, this example uses sorbitane monooleate that is inserted in a typical buffer where it dissolves in the container 101. For example, the buffer solution may be a dissolved mixture of 2-6 liters of deionized water, 200-300 grams of Sodium Chloride, 70-80 grams of Sodium Citrate and 1-2 grams of Calcium Chloride. Next, the container 101 is placed on a stir plate and mixed at a room temperature until all of the sorbitane monooleate is dissolved into the standard buffer, which may take up to 2 or more hours. A shaker is then used to completely dissolve the contents of the container 101 into the solvent of the first large molecular weight marker (thyroglobulin) and the second large molecular weight marker (sorbitane monooleate).

Next, at block 203 the first large molecular weight marker and the second large molecular weight marker are filtered and separated by the membrane 109c in the filtration unit 109. Even though only the first large molecular weight marker and the second large molecular weight marker are filtered and separated by the membrane 109c, this membrane 109c may separate more than 2 or a plurality of molecular weight markers from the solution 101 or solution 105a. The reservoir 105 utilizes the second conduit 107 to transfer the solution 105a into the filtration unit 109 that has a membrane 109c, which separates the first large molecular weight marker from the second large weight marker, then transfers it through conduit 111 to the second container 113 where it is becomes a permeate solution 113a. Permeate solution 113a represents a solution that is filtered by the membrane 109c that includes a surfactant, protein or any other type of biological solution. In an embodiment of the invention, the membrane 109c may have a filter serial No. of 998392081697 of 90622079859 and a catalog number of UFP-500-C-3M or UFP-500-C-MA. Hollow fiber 109c or membrane 109c or human papilloma virus membrane 109c are manufactured by GE Healthcare, 14 Walkup drive, Westborough, Mass. 01581. UFP represents ultrafiltration membrane and a microfiltration membrane may be used in place of a UFP. For the protein thyroglobulin, this solution is circulated through the membrane 109c at a transmembrane pressure of 10 psi over a 2 hour time period. In another embodiment of the invention, when the protein is apoferrintin this solution is filtered by circulating it through membrane 109c at a transmembrane pressure of 10 psi over a 2 hour time period. In another embodiment of the invention, membrane 109c may be referred to as a Human Papilloma virus (HPV) removal membrane if the surfactant is PS 80 and the protein is thyroglobulin and if this membrane is utilized for the separation of the HPV vaccine from the PS 80 surfactant.

At block 205, there is a determination if the first large molecular weight marker is equal to or larger than the first target concentration (described above). At this point the solution 101a or the feed solution and the permeate solution 113a is collected respectively in a first cuvette 117a and the second cuvette 117b. In another embodiment of the invention, the first and second cuvettes 117a and 117b may be replaced with a container capable of holding the feed solution 101a and the permeate solution 113a. The feed solution 101a in the first cuvette 117a has the same concentration as the first target concentration that it had when it was inserted into the container 101, but this feed solution 101a may be poured into the spectrometer 119 to determine the protein concentration in the feed solution 101a. Permeate solution 113a in the second cuvette 117b is put into the spectrometer 119 to determine its level of protein concentration. When the protein concentration in the feed solution 101a and the protein concentration in the permeate solution 113a is determined by employing the spectrometer 119, then the first large molecular weight marker or the protein rejection is determined by the following equation:

PROTEIN REJECTION=((PROTEIN CONCENTRATION IN FEED SOLUTION−PROTEIN CONCENTRATION IN PERMEATE SOLUTION)/(PROTEIN CONCENTRATION IN FEED SOLUTION))×100%

The protein rejection is calculated by employing the computer 121 whereby the spectrometer 119 provides the results of the protein concentration in feed solution 101a and the protein concentration in permeate solution 113a to a user that inputs these results or information into the computer 121 that calculates the protein rejection or the first large molecular weight marker. The first cuvette 117a, second cuvette 117b, third cuvette 117c and fourth cuvette 117d, spectrometer 119 and the computer 121 components may be referred to collectively as a measuring system.

If the first large molecular weight marker is equal to or larger than the value of the first target concentration then a first criteria is met then the process goes to block 207. However, if the first large molecular weight marker is not equal to or larger than the value of the first target concentration then the first criteria is not met, then this process is repeated until the first large molecular weight marker is equal to or larger than the value of the first target concentration and then this process ends.

Next at block 207, there is a determination if the second large molecular weight marker is equal to or smaller than a second target concentration. At this point the solution 101a or the feed solution and the permeate solution 113a is collected respectively in the third cuvette 117c and the fourth cuvette 117d. In another embodiment of the invention, the third cuvette 117c and fourth cuvette 117d may be replaced with a container capable of holding the feed solution 101a and the permeate solution 113a. The feed solution 101a in cuvette 117c has the same concentration that it had when it was inserted into the container 101, but this feed solution 101a may be poured into the spectrometer 119 to determine the surfactant concentration in the feed solution 101a. Permeate solution 113a held in cuvette 117d is put into the spectrometer 119 to determine its level of surfactant concentration. When the surfactant concentration in the feed solution 101a and the surfactant concentration in the permeate solution 113a is determined by employing the spectrometer 119, then the second large molecular weight marker or the surfactant rejection is determined by the following equation:

SURFACTANT REJECTION=((SURFACTANT CONCENTRATION IN FEED SOLUTION−SURFACTANT CONCENTRATION IN PERMEATE SOLUTION)/(SURFACTANT CONCENTRATION IN FEED SOLUTION))×100%

The surfactant rejection is calculated by using the computer 121 whereby the spectrometer 119 provides the results of the surfactant concentration in feed solution 101a and the surfactant concentration in permeate solution 113a to a user that inputs these results or information into the computer 121 that calculates the surfactant rejection. If the second large molecular weight marker is equal to or smaller than the value of the second target concentration then a second criteria is met then this process ends. However, if the second large molecular weight marker is not equal to or smaller than the value of the second target concentration then the second criteria is not met and this process is repeated until the second large molecular weight marker is equal to or smaller than the value of the second target concentration then this process ends.

In an example, Table 1 shows the results of determining the protein rejection and surfactant rejection for the hollow fibers A, B and C based on the Protein, Surfactant, a biological/pharmaceutical criteria or the size of the hollow fibers A, B and C.

TABLE 1

Hollow Fiber Membranes

| | | A | B | C |
|---|---|---|---|---|
| Premise | Protein | P ≧ 1 | P ≧ 1 | P < 1 |
| | Surfactant | S > 1 | S ≦ 1 | S ≦ 1 |

| | | | |
|---|---|---|---|
| Biotechnology | Fail | Pass | Fail |
| pharmaceutical criteria | | | |
| Membrane pore size | Too small | Right range | Too big |

This table 1 includes the notations: P=[P]/[Pₒ] and S=[S]/[Sₒ]. The notation [P] represents Protein Concentration in retentate, which is equal to protein concentration in Feed Solution−Protein Concentration in Permeate Solution based on mass balance. Pₒ is the minimum target protein concentration in the desired product. The notation [S] represents Surfactant Concentration in retentate, which is equal to surfactant concentration in Feed Solution−Surfactant Concentration in Permeate Solution. Sₒ is the maximum target surfactant concentration in the desired product.

For hollow fiber A, the membrane pore size may be too small, the membrane filtration 109 will give a protein concentration equal to or higher than the targeted concentration (P≧1), and a concentration of surfactant (or buffer or other agent) higher than the targeted concentration (S>1). In case of the hollow fiber B, the membrane pore size and pore size distribution are in a right range, the membrane filtration will yield a protein concentration equal to or higher than the targeted protein concentration (P≧1), and a concentration of surfactant (or buffer or other agent) equal to or lower than the targeted concentration (S≦1). For the hollow fiber C, the membrane pore size is too large, the membrane filtration will give a protein concentration less than the targeted concentration (P<1), and a concentration of surfactant (or buffer or other agent) also equal to or less than the targeted concentration (S≦1).

However, only when both conditions: P≧1 and S≦1, are satisfied, the biotechnological/pharmaceutical criteria or the first criteria for protein retention, and the second criteria for surfactant passage are met and the membrane 119c will be qualified for use in biotech and pharmaceutical industries. In the above criteria, the absolute value of [P₀] and [S₀] may vary independently, but the critical ratios, P=[P]/[P₀], and S=[S]/[S₀] for the criteria remain unchanged. Such classification and definition provide universal standards and criteria, independent of chemical compositions and the absolute values of [P₀] and [S₀], for membrane product quality control.

In another example, Table 2 based on Table 1 also shows the results of determining the results based on the polyvinylpyrrolidone (PVP-K30) molecular weight marker for hollow fibers A, B and C.

TABLE 2

| | | Hollow Fiber Membranes | | |
|---|---|---|---|---|
| | | A | B | C |
| Premise | Protein | P ≧ 1 | P ≧ 1 | P < 1 |
| | Surfactant | S > 1 | S ≦ 1 | S ≦ 1 |
| Biotechnology/pharmaceutical | | Fail | Pass | Fail |
| criteria | | | | |
| Test results | PVP K30 | Fail | Fail | Pass |

| | | | |
|---|---|---|---|
| Membrane pore size | Too small | Right range | Too big |

For the hollow fiber A, the PVP-K30 separation test fails while the internal pore sizes of this fiber is small. For the hollow fiber B, the PVP-K30 separation test fails while the internal pore of this fiber is in the right range. In case of the hollow fiber C, the PVP-K30 separation test passes while the internal pore sizes of the fiber is too big. The data in Table 2 indicate that PVP-K30 molecular weight marker can not provide reliable data for product quality control.

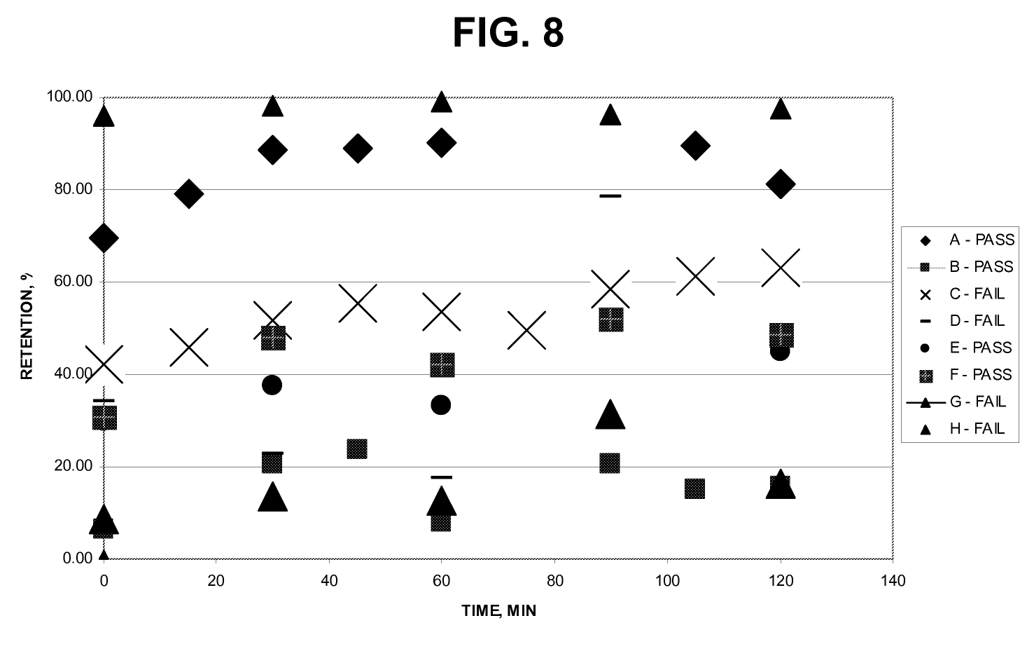

FIG. 8 shows a graphical representation of apoferrintin in the hollow fibers or membrane 119c versus time. Apoferrintin represents the first large molecular weight marker that can be utilized with a specialized hollow fiber or membrane used for removal of a human papilloma virus (HPV)

For this purpose, apoferrintin having molecular weight of 481.2 kDa is selected as a molecular weight marker. The 1000 ppm apoferrintin is in a buffer solution (hereafter referred as Buffer-M) comprising may be 1-3 M of sodium chloride, 40-60 mM of sodium citrate basic dehydrate, 1-3 mM of calcium chloride at pH 6.0-6.3. Preferably, the buffer solution is 1 M of sodium chloride, 50 mM of sodium citrate basic dehydrate, 2 mM of calcium chloride at pH 6.2 that is filtered by several different batches of HPV membranes or hollow fibers 109c.

The retention of apoferrintin is plotted as a function of filtration time. The apoferrintin solution was filtered by circulating it through a HPV membrane 109c at a transmembrane pressure of 10 psi over 2 hrs time period. After 30 minutes of filtration in a circulation mode, the retention of apoferrintin by HPV membranes 109c or hollow fiber membranes A, B and C approaches a relative steady value and becomes independent of filtration time. Unfortunately, no clear trend can be found from these test results for the membranes which have either passed or failed the tests. These results suggest that the separation behavior of the apoferrintin by HPV membranes is dramatically different from that of particle-like HPV vaccine (U.S. Pat. Nos. 6,602,697 and 6,358,744).

The feed and permeate samples were collected at 15 minute time intervals for measuring flux and rejection. The apoferrintin concentration in feed and permeate was measured by UV absorption by spectrometer 119 at 280 nm.

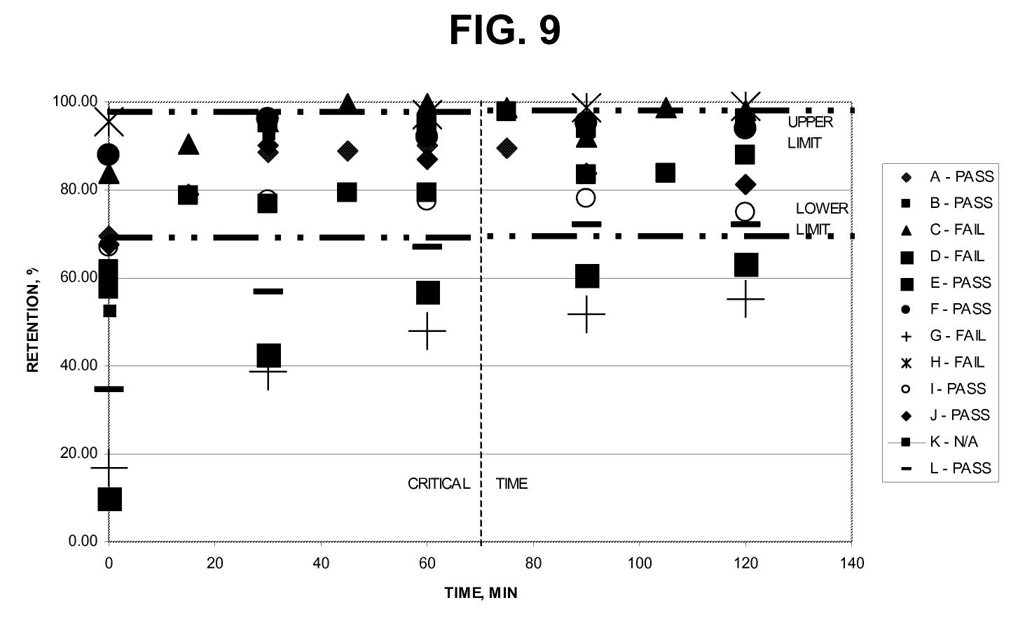

FIG. 9 shows a graphical representation of thyroglobulin in the hollow fiber or membrane 119c versus time. Thyroglobulin represents the first large molecular weight marker that can be utilized with a membrane, 109c, specialized for removal of a surfactant from a human papilloma virus (HPV) vaccine in a buffer solution Thyroglobulin is utilized to evaluate the HPV membrane 109c as thyroglobulin goes through the filtration process described in FIG. 2. A 1000 ppm thyroglobulin in buffer-M (described above) is filtered in a recirculation mode by several different batches of HPV membrane 109c. The thyroglobulin solution was filtered by circulating it through a HPV membrane 109c at a transmembrane pressure of 10 psi over 2 hrs time period. After 75 minutes of going through the filtration process, the retention of thyroglobulin at the membrane 109c approaches a constant value, which could be used as a criteria to evaluate membrane 109c performance for membrane product quality control. Therefore, the filtration time of 75 minutes is selected as a critical time, T_{c}, after this critical filtration time a steady state is established.

After drawing two straight lines at thyroglobulin retention at 70% and 97%, respectively, it was found that all of the membranes having thyroglobulin retention between these two lines, i.e., 70%≦thyroglobulin retention≦97%, have passed a certain test by separation of HPV Vaccine from PS 80 surfactant. The pore size of the membranes 109c that have thyroglobulin retention that is less than 70% are too big to retain HPV vaccine to the desired concentration. On the other hand, the pore size of the membranes 109c that have thyroglobulin retention higher than 97% is too small to let PS 80 surfactant through the membrane, thus the concentration of PS 80 in the retentate exceeds allowed limit to result in a failure. This surprising discovery is shown in Table 3.

TABLE 3

| | | Hollow Fiber Membranes | | |
|---|---|---|---|---|
| | | A | B | C |
| Premise | Protein | P ≧ 1 | P ≧ 1 | P < 1 |
| | Surfactant | S > 1 | S ≦ 1 | S ≦ 1 |
| Biotech Criteria | | Fail | Pass | Fail |
| Test results | PVP K30 | Fail | Fail | Pass |
| | Customer test | Fail | Pass | Fail |
| | Thyroglobulin | >97% | 70% ≦ R ≦ 97% | <70% |
| | | Fail | Pass | Fail |

| | | | |
|---|---|---|---|
| Membrane pore size | Too small | Right range | Too big |

The thyroglobulin concentration in both the permeate and feed solutions are measured by UV absorption of the spectrometer 119 at 280 nm as a function of filtration time as shown. The retention of thyroglobulin increases with filtration time at the beginning; the slope of the retention—time curves of the membranes having lower thyroglobulin retention is larger than that of the membranes having higher thyroglobulin retention as shown in FIG. 9.

This invention provides a system and a method that allows a user to characterize a membrane based on a user prescribed criteria to meet the specific needs of the user. The user is able to characterize a membrane by comparing the first target concentration of larger solute, such as protein, cell fragment and whole cell with a first large molecular weight marker; and by comparing the second target concentration of smaller solute, such as amino acid, nucleotide, antibiotics and surfactant with the second large molecular weight marker. If the first large molecular weight marker is equal to or larger than the first target concentration or a protein concentration then a first criteria set by a user is met for product retention by the membrane. If the second large molecular weight marker is equal to or smaller than the second target concentration than a second criteria prescribed by a user is met for the passage of smaller molecules through the membrane.

The present invention is more advanced than the prior art in that the present invention has two separation criteria, one for larger solute retention by the membrane and another for the smaller solute passage through the membrane. In the prior art, the criteria used for evaluation of membrane is solely based on the retention or rejection data, which has been proven to be inadequate in meeting the needs of biotech and pharmaceutical industries. For the present invention, the problems that prior art was unable to solve or address are successfully solved by using two universal criteria, i.e., one for rejection and another for passage as described above. However, this invention can also three or more universal criteria to meet the needs of the biotech and pharmaceutical industries. This remarkable achievement sets the present invention apart from the prior art. The methodology discovered in this invention adequately services the needs of both membrane manufactures and biotech/pharmaceutical industries. Therefore, the present invention is superior to the prior art.

Although the present invention has been described above in terms of specific embodiments, many modification and variations of this invention can be made as will be obvious to those skilled in the art, without departing from its spirit and scope as set forth in the following claims.

What is claimed is:

1. A system for characterizing a membrane, comprising:
a first container configured to dissolve a first large molecular weight marker and a second large molecular weight marker into a solution, wherein the first container is connected to a reservoir;
the first molecular weight marker is selected for measuring retention by a membrane, while the said second largest molecular marker is selected for measuring passage through the membrane;
the reservoir is configured to store a feed solution and to receive a recycled concentrated solution;
a filtration unit connected to the reservoir, wherein the filtration unit is configured to separate the first large molecular weight marker from the second large molecular weight marker in the solution;
a measuring system configured to determine if the first large molecular weight marker is equal to or larger than a first target concentration, wherein if the first large molecular weight marker is equal to or larger than the first target concentration then the first large molecular weight marker it meets a first criteria for rejection by said membrane; and
the measuring system is configured to determine if the second large molecular weight marker is equal to or smaller than a second target concentration, wherein if the second large molecular weight marker is equal to or smaller than the second target concentration then the second large molecular weight marker it meets a second criteria for passage through said membrane.

2. The system of claim 1, wherein the measuring system is comprised of a first cuvette, second cuvette, third cuvette, a fourth cuvette, a spectrometer and a computer.

3. A method for characterizing a membrane comprising:
forming a solution by dissolving a first large molecular weight marker and a second large molecular weight marker in a solvent;
filtering said solution, wherein said first large molecular weight marker and said second large molecular weight marker are separated;
determining if the first large molecular weight marker is equal to or larger than a first target concentration, wherein if the first large molecular weight marker is equal to or larger than the first target concentration then the first large molecular weight marker meets a first criteria for retention by a membrane; and
determining if the second large molecular weight marker is equal to or smaller than a second target concentration, wherein if the second large molecular weight marker is equal to or smaller than the second target concentration then the second large molecular weight marker meets a second criteria for passage through said membrane

4. The method of claim 3, wherein the first large molecular weight marker is comprised of a protein.

5. The method of claim 3, wherein the second large molecular weight marker is comprised of a surfactant.

6. The method of claim 3, wherein said first large molecular weight marker is a chemical from the group comprising thyroglobulin, apoferrintin, hemoglobulin, monoclonal antibody, bovine serum albumin.

7. The method of claim 3, wherein the second large molecular weight marker is a chemical from the group comprising sorbitane monooleate, tween 20-85, and triton X-100.

8. The method of claim 3, wherein the first target concentration is a first target protein concentration.

9. The method of claim 3, wherein the second target concentration is a first target surfactant concentration.

10. The method of claim 3, wherein the first criteria is a desired protein concentration.

11. The method of claim 3, wherein the second criteria is a desired surfactant concentration.

12. The method of claim 1, wherein the solvent is a buffer.

13. The method of claim 5, wherein the surfactant is an agent.

14. The method of claim 3, wherein the first large molecular weight marker is separated from the second large molecular weight marker by a filtration unit.

15. The method of claim 14, wherein the filtration unit includes a membrane.

16. The method of claim 15, wherein the membrane is selected from a group comprising a hollow fiber membrane, flat sheet membrane and tubular membrane

17. The method of claim 16, further comprising:
removing Human Papilloma Virus (HPV) vaccine from a surfactant in a buffer solution by utilizing the membrane.
